(19) United States
(12) Patent Application Publication
(10) Pub. No.: US 2005/0081355 A1
(43) Pub. Date: Apr. 21, 2005

(54) Air disc brake caliper jack assembly

(76) Inventor: Robert J. Nechvatal, Columbia Station, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/687,325

(22) Filed: Oct. 16, 2003

(51) Int. Cl. B23P 19/04; B23P 19/00

(52) U.S. Cl. 29/426.5; 29/426.1; 29/239

(57) ABSTRACT

A jack assembly is provided for supporting a brake assembly, particularly an air disc brake caliper. The jack assembly includes a base having a telescoping cylinder that extends therefrom. A support member is secured on an opposite end of the cylinder and includes a securing arrangement for attaching the support member to an associated brake carrier. The support member is rotated about a vertical axis, translated along an horizontal plane provided by the wheels on the base, raised and lowered in height by the selectively extending cylinder, and/or pivoted along a connection with the cylinder. In this manner, the jack assembly is advantageously positioned adjacent the brake assembly, the caliper housing secured to the jack assembly, and then the jack assembly carries the caliper housing to a desired location for service.

### BACKGROUND OF THE INVENTION

This application relates to commercial vehicle systems, and particularly heavy vehicles that use air disc brakes. Briefly, and as is generally known, a revolving disc is used for heavy duty braking operations and achieves a required braking force through a caliper assembly that uses brake linings carried on pistons to squeeze or grip opposite faces of the revolving disc. Over time, and after frequent use, it becomes necessary to service and/or replace the brakes of the vehicle and to remove the brake caliper and/or brake carrier. Some brake caliper assemblies weigh approximately one hundred pounds, and depending on the work being conducted on the heavy vehicle, could be located as high as five feet off the ground during servicing. This weight and height thus requires a substantial amount of human effort to remove and install, i.e., service, the brakes of the vehicle. A need exists for a tool that advantageously assists in servicing the brakes in a reliable manner.

### SUMMARY OF THE INVENTION

In one embodiment, a jack assembly for supporting a brake assembly includes a base, a selectively extensible member extending from the base, and a support member secured to the extensible member.

In one aspect, the jack assembly further includes a means for securing the support member to an associated brake assembly.

In another aspect, the securing means includes first and second arms having threaded ends for securing the arms to the associated brake assembly.

In another aspect, the securing means includes third and fourth arms. The first, second, third, and fourth arms are in spaced relation.

In another aspect, the support member includes a plurality of arms dimensioned for support of the associated brake assembly.

In another aspect, the support member is mounted to the extensible member for selective pivotal movement relative thereto.

In another aspect, the base includes rollers allowing the assembly to be transported across a floor surface.

In another aspect, the extensible member is rotatable for selective movement about a vertical axis relative to the base.

In another aspect, the extensible member is a fluid cylinder.

In another aspect, the fluid cylinder is pneumatic.

In another aspect, the extensible member is a mechanical actuator.

In another aspect, the extensible member is an electric actuator.

In another embodiment, a method of unmounting/mounting a brake caliper with respect to a heavy vehicle includes positioning a tool adjacent to the brake caliper, unmounting the brake caliper from the vehicle, and mounting the brake caliper to the tool.

In another embodiment, a tool for loading/unloading a brake assembly from a vehicle includes a selectively extensible member extending from a base, and a plurality of arms for supporting the brake housing.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 is a perspective view of the jack assembly in association with a vehicle brake assembly in one embodiment of the present invention.

FIG. 2 is a perspective view of the jack assembly shown in FIG. 1.

FIG. 3 is a perspective overview of the jack assembly shown in FIG. 2 supporting a brake caliper/carrier as it is removed from the vehicle.

FIG. 4 is a view similar to FIG. 3 illustrating the opposite side of the caliper housing secured to the jack assembly.

FIG. 5 is a perspective view of a jack assembly in association with a vehicle brake assembly in another embodiment of the present invention.

### DETAILED DESCRIPTION OF ILLUSTRATED EMBODIMENT

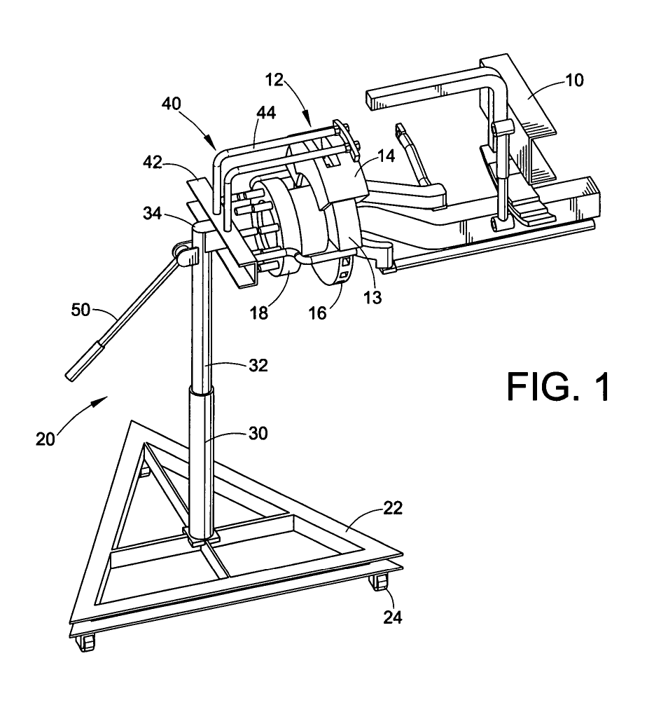

FIG. 1 illustrates a frame 10 of an associated heavy vehicle to which is rotatably mounted a wheel having a disc brake assembly 12. The brake assembly 12 includes a caliper 14, a carrier 13, and a brake chamber (housing) (not shown). Associated with the assembly 12 is a rotating disc 16 spaced inwardly from a wheel hub 18 to which is typically secured a wheel carrying a tire (not shown). When the brakes are applied, pressurized air actuates piston assemblies provided in a caliper fashion onto one face of the rotating disc 16. The sliding action of the caliper 14 provides the actuation mechanism for the opposite face of the disc. The linings (not shown) are moved into frictional engagement with the opposite surfaces of the disc and provide the desired wheel braking for the vehicle. The linings periodically require servicing or replacement, as does the remainder of the brake assembly, and upon removal of the wheel and tire a mechanic can gain access to the assembly 12. In one embodiment, the brake chamber (not shown) that provides the actuating force to the pistons and lining of the caliper is removed so that a jack assembly (tool) 20 formed in accordance with the present invention can be used.

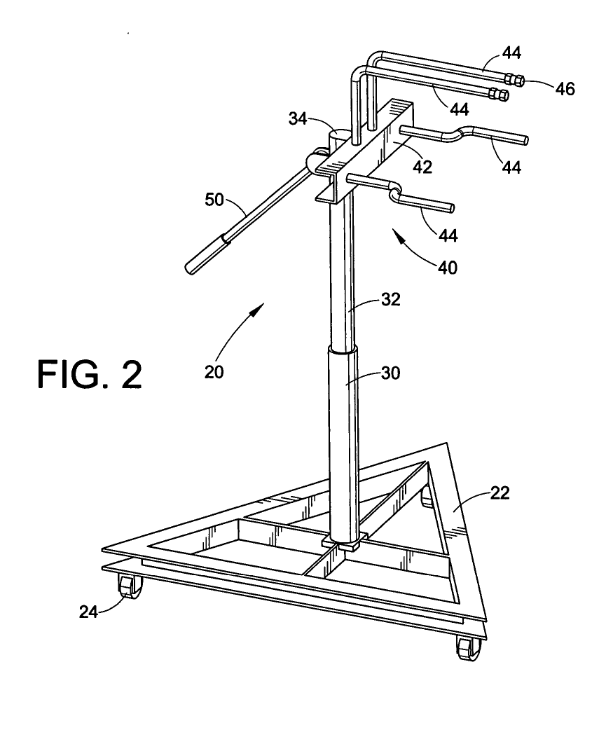

More particularly, and in addition to FIG. 1, the jack assembly 20 is individually shown in FIG. 2. It includes a base 22, shown here as a triangular formation -having means for translating or moving the jack assembly across the ground surface. Here, three wheels 24 are employed at each apex of the triangular base. Of course, it will be recognized that if a different conformation of the base assembly is used, a greater or lesser number of wheels or other rolling means may be used with equal success. Extending outwardly from the base is an extensible member or linear displacement mechanism 30. In one embodiment, the extensible member is a telescoping fluid cylinder that selectively extends and retracts in response to fluid pressure applied to the piston of the piston cylinder/cylinder assembly. Thus, a rod or linear member 32 is selectively raised and lowered in response to the fluid pressure so that an upper, terminal end 34 is moved to a desired height. It is also contemplated that the extensible member 30 include a mechanical actuator and/or an electric actuator.

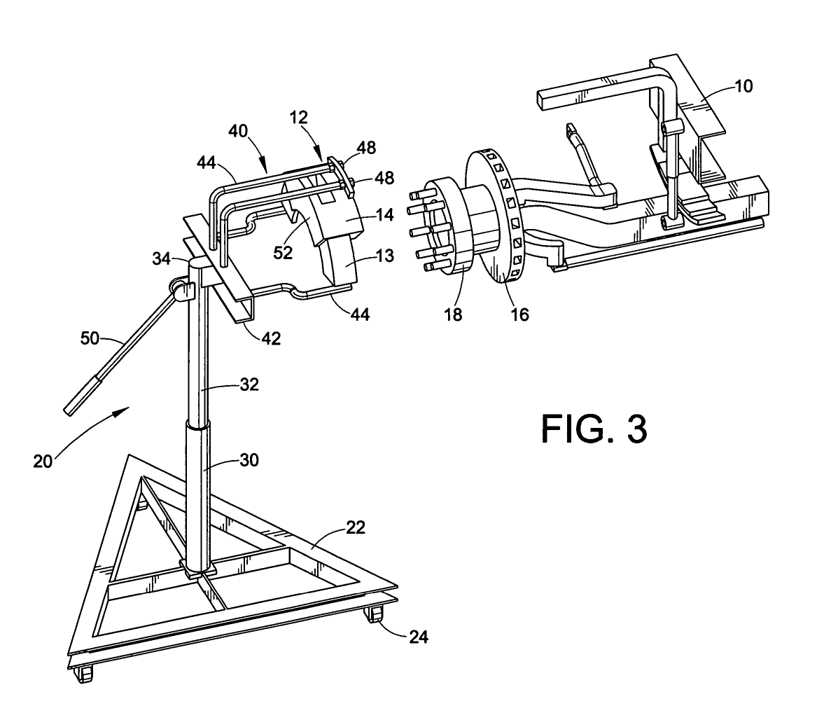

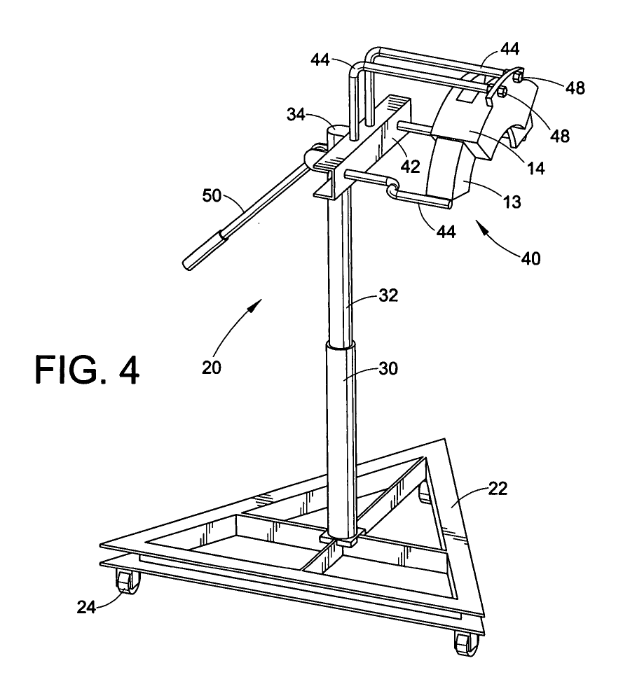

A support member 40 is mounted to the upper end of the linear displacement cylinder 30. The support member in the illustrated arrangement includes a bracket 42 from which individual, spaced arms 44 extend in a desired fashion. Here, four such arms are employed and are disposed in generally parallel relation. Selective ones of the arms include securing means 46 at outer terminal ends for securing the support member to the caliper 14 housing. One arrangement of a securing means uses threaded ends on two or more of the arms so that in conjunction with fastener nuts 48 (FIGS. 3 and 4), the arms are secured to the caliper 14 (FIGS. 3 and 4). As noted above, the brake chamber was previously removed, thereby providing openings in the caliper housing to receive the outer threaded ends of the first and second arms. The third and fourth arms provide bearing support for the weight of the caliper housing, i.e., allowing lower edges of the caliper housing to rest thereon and provide a stable support for the assembly.

A boom 50 allows the support member to be selectively rotated about a vertical axis defined by the telescoping cylinder. It can also provide pivoting action at its connection point therewith. In addition to the adjustment provided by the extensible, telescoping cylinder, the wheeled base provides the translation for horizontal movement.

In operation, a mechanic can raise or lower the support member of the jack assembly to the desired height. The outer ends of the support members are aligned and positioned in desired orientation with the caliper 14. In one embodiment, at least two of the arms are aligned with openings of the caliper 14 that are provided when the brake chamber is removed from the assembly 12 (see FIG. 1). The caliper 14 is then unloaded (unmounted) from the wheel hub and loaded (mounted) onto the arms 44 of the support member 40 via the openings. In this manner, the caliper 14 is attached to the tool 20. The caliper 14 is then secured to the member 40 via the fastener nuts 48 (see FIGS. 3 and 4). Once secured, the jack assembly 20 is moved away from the wheel hub 18 and the cylinder 30 is positioned to a desired height and moved to a desired location where servicing of the brake assembly 12 is completed. Once completed, the serviced brake assembly is again secured to the support arms 44 and the jack assembly 20 moved into position relative to the wheel hub 18. The fastener nuts 48 are then removed from the threaded ends of the support arms 44. The brake assembly 12 is then unloaded (unmounted) from the arms 44 of the jack assembly 20 and loaded (mounted) onto the wheel hub 18. Thereafter, the jack assembly 20 is removed from its support position adjacent the wheel hub 18 and the brake chamber re-attached along with the wheel and tire assembly.

The embodiment of the tool described above includes a base 22, a linear displacement mechanism 30 and a connection point for the brake assembly 12, as well as an optional boom extension mechanism 50 to reduce the human effort required in the removal and installation process. It provides for time savings as well as flexibility during installation by providing greater control of the caliper movement. The linear displacement mechanism 30 allows for vertical and rotational movement of the brake assembly 12 about the longitudinal axis of the linear displacement mechanism 30. Connection of the linear displacement mechanism 30 or some other location allows for rotational movement about two or more axes at the connection point. By rolling the tool into position underneath or adjacent the vehicle wheel end containing the brake assembly 12 to be removed, the brake can hover over the wheel end while the jack assembly 20 is still out of the way. The linear displacement mechanism 30 is then extended to place the brake in close proximity to its final location on the vehicle. The cylinder shaft can be rotated, which rotates the brake, and the brake can also be rotated at the connection point in the cylinder. These rotations, along with extension or retraction of the hydraulic cylinder, are performed until the brake is in the final, desired position for installation of the mounting fasteners or nuts 48.

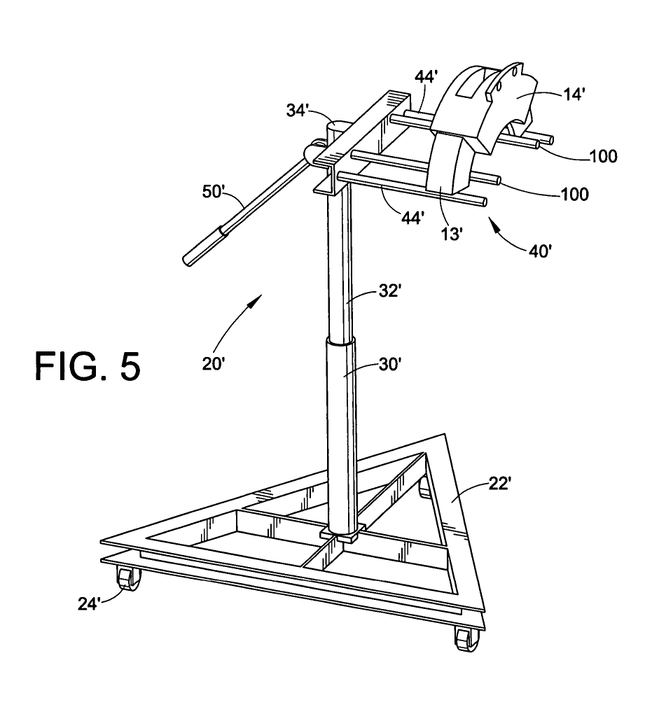

Another embodiment is illustrated in FIG. 5. For ease of understanding this embodiment of the present invention, like components are designated by like numerals with a primed (′) suffix and new components are designated by new numerals. In this embodiment, the support member 40′ includes spaced arms 44′ along with arms 100. In this embodiment, the carrier 13′ and caliper 14′ are cradled in the arms 44′, 100, which provide bearing support for the weight of the carrier 13′ and caliper 14′. In this embodiment, the carrier 13′ and caliper 14′ merely rest on the arms 44′, 100. Therefore, unlike the embodiment illustrated in FIGS. 1-4, the arms 44′, 100 do not pass through openings in the caliper housing 14′. Consequently, the tool 20′ illustrated in FIG. 5 may be used with various caliper having different arrangements of openings for securing a housing.

The invention has been described with reference to the illustrated embodiment. Modifications and alterations will occur to others upon a reading and understanding of the preceding detailed description. It is intended that the invention be construed as including all such modifications and alterations insofar as they come within the scope of the appended claims or the equivalents thereof.

1. A jack assembly for supporting a brake assembly, the jack assembly comprising:
a base;
a selectively extensible member extending from the base; and
a support member secured to the extensible member.

2. The jack assembly of claim 1, further including:
means for securing the support member to an associated brake assembly.

3. The jack assembly of claim 2, wherein the securing means includes first and second arms having threaded ends for securing the arms to the associated brake assembly.

4. The jack assembly of claim 3, wherein:
the securing means includes third and fourth arms; and
the first, second, third, and fourth arms are in spaced relation.

5. The jack assembly of claim 1, wherein the support member includes a plurality of arms dimensioned for support of the associated brake assembly.

6. The jack assembly of claim 1, wherein the support member is mounted to the extensible member for selective pivotal movement relative thereto.

7. The jack assembly of claim 1, wherein the base includes rollers allowing the assembly to be transported across a floor surface.

8. The jack assembly of claim 1, wherein the extensible member is rotatable for selective movement about a vertical axis relative to the base.

9. The jack assembly of claim 1, wherein the extensible member is a fluid cylinder.

10. The jack assembly of claim 9, wherein the fluid cylinder is pneumatic.

11. The jack assembly of claim 1, wherein the extensible member is a mechanical actuator.

12. The jack assembly of claim 1, wherein the extensible member is an electric actuator.

13. A method of unmounting/mounting a brake caliper with respect to a heavy vehicle, the method comprising:
positioning a tool adjacent to the brake caliper;
unmounting the brake caliper from the vehicle; and
mounting the brake caliper to the tool.

14. The method of claim 13, further comprising:
removing a brake chamber from the brake caliper before mounting the caliper to the tool.

15. The method of claim 13, wherein the mounting step includes:
attaching the tool to the brake caliper via openings in the caliper.

16. The method of claim 15, wherein the mounting step further includes:
securing the brake caliper to the tool.

17. The method of claim 16, wherein the securing step includes:
fastening the tool to the brake caliper.

18. The method of claim 13, wherein the positioning step includes:
aligning first and second arms of the tool with openings of the brake caliper.

19. The method of claim 13, wherein the mounting step includes:
cradling the caliper in a plurality of arms on the tool.

20. A tool for loading/unloading a brake assembly from a vehicle, comprising:
a selectively extensible member extending from a base; and
a plurality of arms for supporting the brake housing.

21. The tool for loading/unloading a brake assembly as set forth in claim 20, wherein the arms are arranged to be in alignment with openings in the brake assembly, the brake assembly being loaded onto the vehicle and unloaded from the vehicle via the openings.

22. The tool for loading/unloading a brake assembly as set forth in claim 21, further comprising:
fasteners for securing the brake assembly on the arms.

23. The tool for loading/unloading a brake assembly as set forth in claim 20, further comprising:
a base secured to the extensible member.

24. The tool for loading/unloading a brake assembly as set forth in claim 23, further comprising:
means for moving the base.

25. The tool for loading/unloading a brake assembly as set forth in claim 24, wherein the means for moving the base includes wheels.

26. The tool for loading/unloading a brake assembly as set forth in claim 21, further comprising:
a boom for rotating the support member about a vertical axis defined by the extensible member.
